(19) United States
(12) Patent Application Publication
(10) Pub. No.: US 2025/0355998 A1
(43) Pub. Date: Nov. 20, 2025

(54) MONITORING CLOSED SYSTEMS FOR SECURITY AND/OR PERFORMANCE ISSUES

(71) Applicant: International Business Machines Corporation, Armonk, NY (US)

(72) Inventors: Brian James Cagno, Tucson, AZ (US); Matthew G. Borlick, Tucson, AZ (US); Lokesh Mohan Gupta, Tucson, AZ (US)

(21) Appl. No.: 18/667,869

(22) Filed: May 17, 2024

(51) Int. Cl. G06F 21/55; G06F 11/34

(52) U.S. Cl. CPC G06F 21/552; G06F 11/3495; G06F 2221/034

(57) ABSTRACT

A computer-implemented method, according to one approach, includes: determining a number of processes and threads for each of a plurality of programs currently running on a closed system. For each of the programs in the plurality of programs, a determination is made as to whether the respective number of processes and threads are in a first predetermined range. Moreover, for each of the programs determined as having a respective number of processes and threads that are in the first predetermined range, CPU usage associated with the respective programs is determined. A security alert is issued in response to determining that at least one of the programs include: a respective number of processes and threads that are outside the first predetermined range, and a combined CPU usage that is outside a second predetermined range.

### BACKGROUND

The present invention relates to closed systems, and more specifically, this invention relates to monitoring operation in closed systems.

Data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices.

This issue has also become more prevalent as the complexity of machine learning models increases. Increasingly complex machine learning models translate to more intense workloads and increased strain associated with applying the models to received data. The operation of conventional implementations has thereby been negatively impacted.

As data production continues to increase, the programs that are used to process the data become more integral to overall system performance. However, open systems can be modified to include any desired number of programs, making it difficult to accurately monitor performance in open systems and identify undesirable situations, e.g., such as memory overflow and/or processing overload. Accordingly, conventional products have been unable to maintain desirable performance during use.

### SUMMARY

A computer-implemented method (CIM), according to one approach, includes: determining a number of processes and threads for each of a plurality of programs currently running on a closed system. For each of the programs in the plurality of programs, a determination is made as to whether the respective number of processes and threads are in a first predetermined range. Moreover, for each of the programs determined as having a respective number of processes and threads that are in the first predetermined range, CPU usage associated with the respective programs is determined. A security alert is issued in response to determining that at least one of the programs include: a respective number of processes and threads that are outside the first predetermined range, and a combined CPU usage that is outside a second predetermined range.

A computer program product (CPP), according to another approach, includes: a set of one or more computer-readable storage media. The CPP also includes program instructions that are collectively stored in the set of one or more storage media, and which are for causing a processor set to perform the foregoing CIM.

A computer system (CS), according to yet another approach, includes: a processor set, and a set of one or more computer-readable storage media. The CS further includes program instructions that are collectively stored in the set of one or more storage media, and which are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for monitoring processes in a closed storage system for performance and/or security related issues. Approaches herein develop nominal operating ranges for closed systems based on manufacturing information, industry standards, testing data, real-time performance, etc. The approaches are thereby able provide an effective way of determining whether the closed system has been manipulated to operate differently than intended, e.g., as the result of malicious activity and/or performance based issues (infinite loops), e.g., as will be described in further detail below.

In one general approach, a CIM includes: determining a number of processes and threads for each of a plurality of programs currently running on a closed system. For each of the programs in the plurality of programs, a determination is made as to whether the respective number of processes and threads are in a first predetermined range. Moreover, for each of the programs determined as having a respective number of processes and threads that are in the first predetermined range, CPU usage associated with the respective programs is determined. A security alert is issued in response to determining that at least one of the programs include: a respective number of processes and threads that are outside the first predetermined range, and a combined CPU usage that is outside a second predetermined range.

In another general approach, a CPP includes: a set of one or more computer-readable storage media. The CPP also includes program instructions that are collectively stored in the set of one or more storage media, and which are for causing a processor set to perform the foregoing CIM.

In yet another general approach, a CS includes: a processor set, and a set of one or more computer-readable storage media. The CS further includes program instructions that are collectively stored in the set of one or more storage media, and which are for causing the processor set to perform the foregoing CIM.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved closed system monitoring code at block 150 for monitoring processes in a closed storage system for performance and/or security related issues. Approaches herein develop nominal operating ranges for closed systems based on manufacturing information, industry standards, testing data, real-time performance, etc. The approaches are thereby able provide an effective way of determining whether the closed system has been manipulated to operate differently than intended, e.g., as the result of malicious activity and/or performance based issues (infinite loops), e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

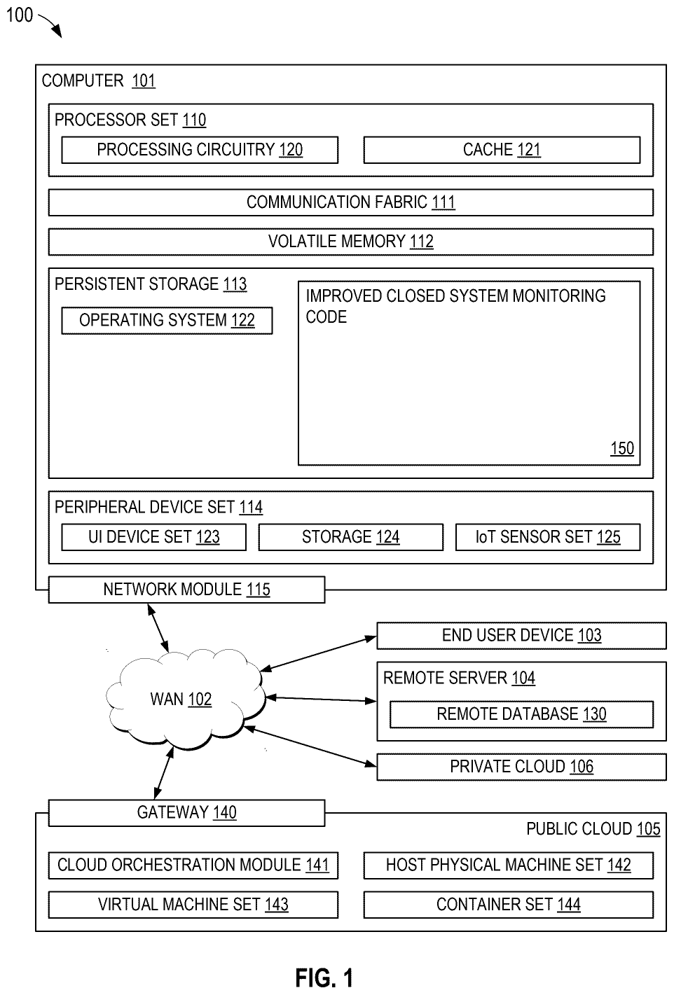

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). It should also be noted that “services” or “microservices” may be used interchangeably with “applications” and “processes” herein. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application program interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data. The operation of conventional implementations has thereby been negatively impacted.

As data production continues to increase, the programs that are used to process the data become more integral to overall system performance. However, open systems can be modified to include any desired number of programs, making it difficult to accurately monitor performance in open systems and identify undesirable situations, e.g., such as memory overflow and/or processing overload. Accordingly, conventional products have been unable to maintain desirable performance during use.

In sharp contrast, approaches herein utilize detailed understandings of closed systems to develop in-depth understandings of how the systems perform. For instance, closed systems may be configured such that they are only able to run programs that are designed to operate on those closed systems. Moreover, the designated programs may only be able to run processes that are controlled by a specific configuration. It follows that processes and threads can be monitored, such that security and/or performance alerts can be generated in certain situations. For example, security and/or performance alerts may be generated in response to observing abnormal numbers of processes and/or threads. In another example, security and/or performance alerts are generated in response to detecting that processing and/or memory overhead is beyond a certain range, e.g., as will be described in further detail below.

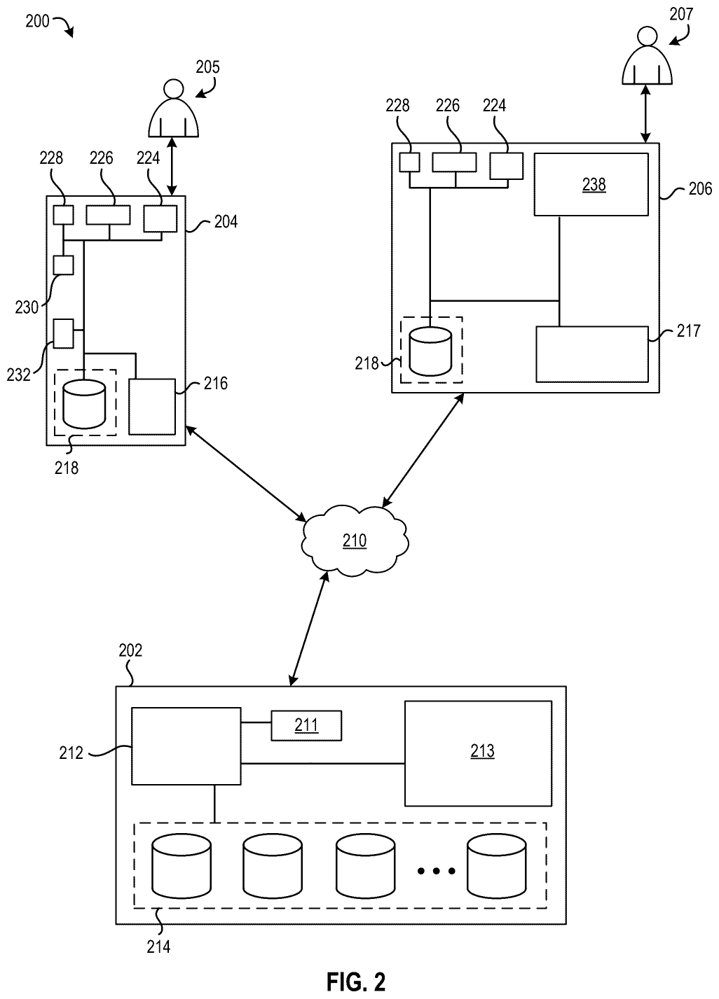

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and closed storage system 206 accessible to the user 205 and administrator 207, respectively. The user device 204 and closed storage system 206 may thereby be considered “endpoint devices,” each of which are connected to the central server 202. The central server 202, user device 204, and closed storage system 206 are each connected to a network 210, and may thereby be positioned in different geographical locations.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, closed storage system 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or closed storage system 206.

It should be noted that two or more of the user device 204, closed storage system 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “datasets,” “metadata,” and “information” herein are in no way intended to be limiting either, and may include any desired type of details, e.g., depending on the type of operating system implemented on the user device 204, closed storage system 206, and/or central server 202.

With continued reference to FIG. 2, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes models that have been trained to evaluate various performance metrics and determine whether the system as a whole is operating nominally. For instance, the AI based models may be configured to detect anomalies in the performance metrics (also referred to herein as “operating characteristics”) of various components in a closed system, and determine what caused the anomalies. In some approaches, the AI based models are able to identify malicious code that has infected the closed system, simply by evaluating CPU overhead, memory usage, a number of processes and threads, and/or other performance metrics that may be available, e.g., depending on the closed system. In some approaches, the AI based models are able to identify performance related issues causing operating characteristics to deviate from nominal operating ranges. It follows that AI module 213 and/or processor 212 may be used to perform one or more of the operations in method 300 below for monitoring processes in a closed storage system for performance and/or security related issues, e.g., as will be described in further detail below.

With continued reference to FIG. 2, user device 204 is a mobile phone that has been provided by an employer. The user device 204 may thereby be limited from installing any new applications, effectively causing the user device 204 to function as a closed system. Looking to the user device 204 itself, a processor 216 is coupled to memory 218. The processor 216 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc.

Because the user device 204 is a closed system which allows limited (if any) changes to be made to operating settings, including installed applications, subprograms, logical components, physical components, subroutines, etc., a detailed understanding of how the user device 204 operates may be developed. For instance, nominal operating ranges may be developed based on manufacturing information, industry standards, testing data, real-time performance, etc.

These “nominal operating ranges” include value ranges for different operating characteristics that a respective closed system is known to exhibit while operating as intended (e.g., as designed). For example, nominal operating ranges may be developed for CPU overhead (e.g., usage), memory consumption, a number of existing processes and threads, and/or other performance metrics that may be relevant to a given closed system while it is powered on and running. This provides an effective way of determining whether the closed system has been manipulated to operate differently than intended, e.g., as the result of malicious activity and/or performance based issues. For example, a malicious program secretly installed in a closed system may be detected as a result of causing CPU overhead, memory consumption, etc., to increase outside respective nominal operating ranges. In another example, code that has become stuck in an infinite loop may cause CPU overhead to increase, threatening the performance of the system as a whole. Monitoring performance of closed systems may thereby desirably provide insight as to how the system as a whole is performing, providing an efficient and effective way of preventing malicious activity and/or performance based issues, e.g., as will be described in further detail below.

With continued reference to FIG. 2, one or more requests may be received at central server 202 from applications (e.g., services) that are running at the user device 204 and/or closed storage system 206. The requests may be received as a result of the user 205 and/or administrator 207 using one or more applications, software programs, temporary communication connections, etc., that are pre-installed in the respective user device 204 and/or closed storage system 206. Looking to closed storage system 206, some of the components included therein may be the same or similar to those included in user device 204, and have therefore been given corresponding numbering. For instance, controller 217 is coupled to memory 218, a display screen 224, keys of a computer keyboard 226, and a computer mouse 228. Additionally, the controller 217 is coupled to an AI module 238. In some approaches, the closed storage system 206 includes hybrid Flash memory and hard disk storage, e.g., such as a DS8000 or the like.

As described above with respect to AI module 213, the AI module 238 may include any desired number and/or type of AI-based models, e.g., such as machine learning models, deep learning models, neural networks, etc. However, in preferred approaches the AI module 238 includes models that have been trained to evaluate various performance metrics and determine whether the system as a whole is operating nominally or as intended. For instance, the AI based models may be configured to detect anomalies in the performance metrics of various components in a closed system, and determine the cause of the anomalies. In some approaches, the AI based models are able to identify malicious code that has infected the closed system, simply by evaluating CPU overhead, memory usage, a number of processes and threads, and/or other performance metrics that may be available, e.g., as described above. It follows that AI module 238 and/or controller 217 may be used to perform one or more of the operations in method 300 below for monitoring processes in a closed storage system for performance and/or security related issues, e.g., as will be described in further detail below.

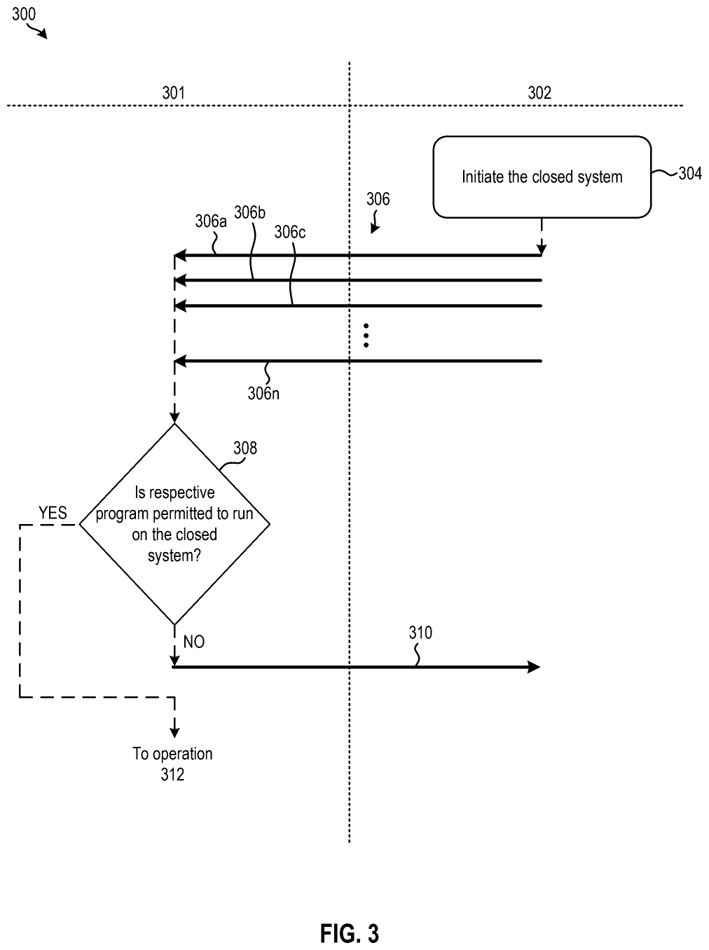

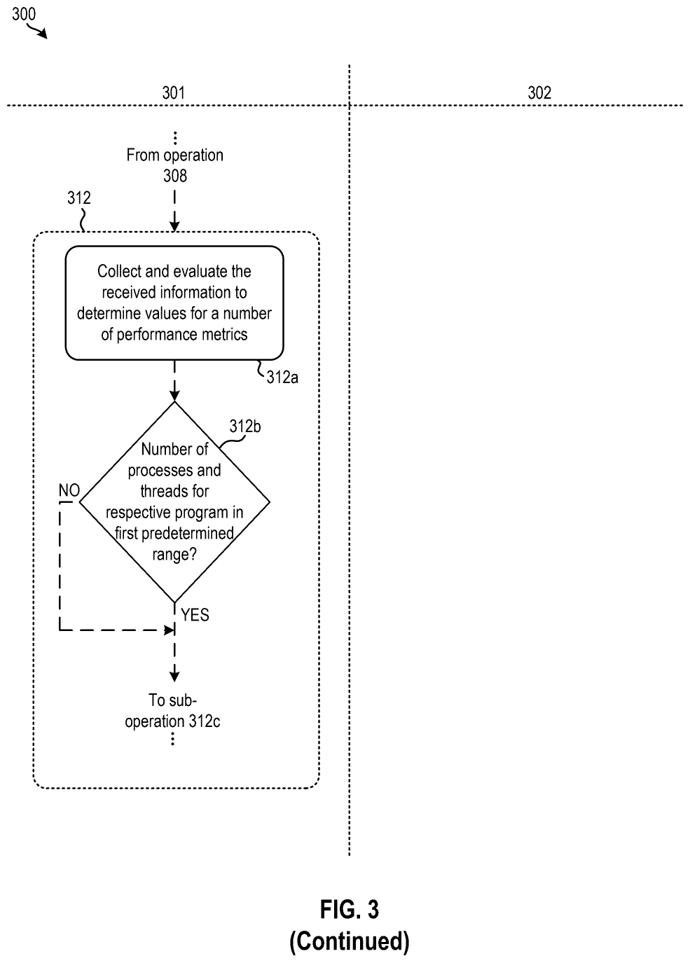

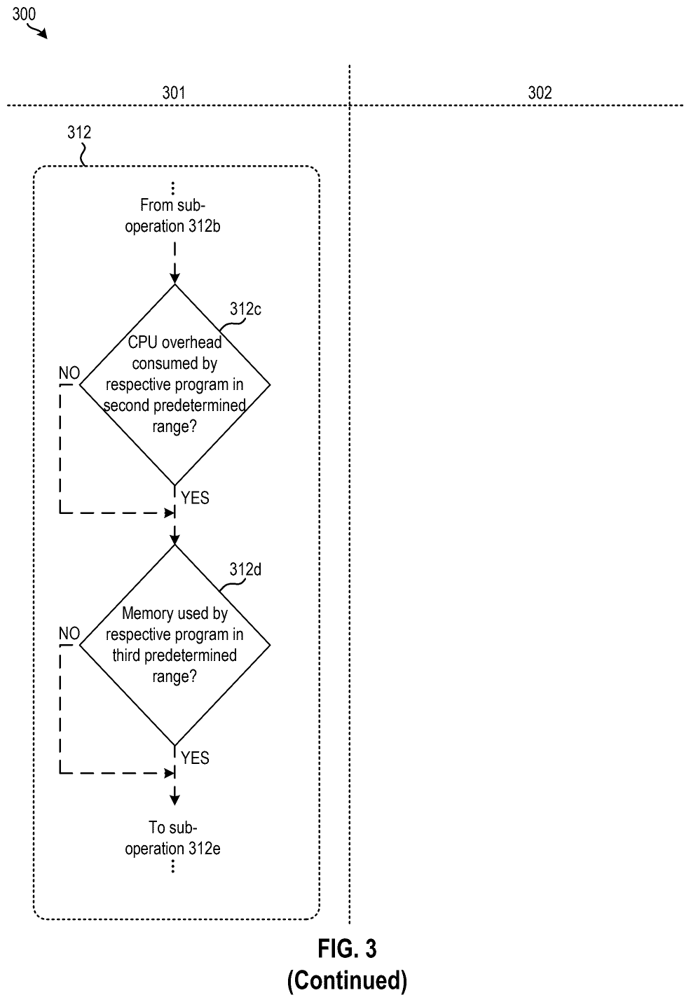

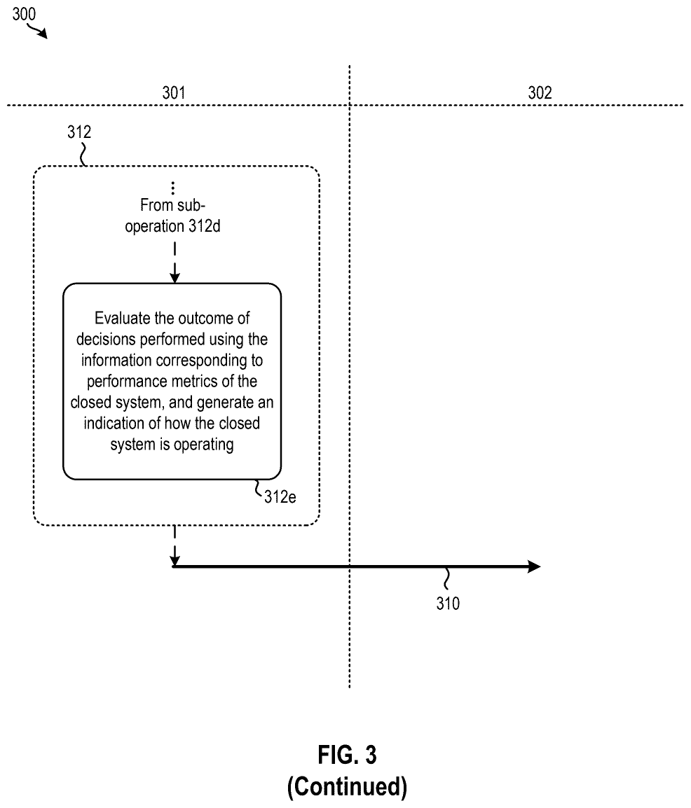

Looking now to FIG. 3A, a flowchart of a computer-implemented-method 300 for monitoring processes in a closed storage system for performance and/or security related issues is illustrated in accordance with one approach. In other words, method 300 includes developing nominal operating ranges for a closed system based on manufacturing information, industry standards, testing data, real-time performance, etc. Approaches herein are thereby able provide an effective way of determining whether the closed system has been manipulated to operate differently than intended, e.g., as the result of malicious activity and/or performance based issues.

The method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions. Each of the steps of the method 300 may be performed by any suitable component of the operating environment. For example, the nodes 301, 302 shown in the flowchart of method 300 may correspond to one or more processors positioned at a different location in a distributed system. Moreover, each of the one or more processors are preferably configured to communicate with each other.

In various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3A includes different nodes 301, 302, each of which represent one or more processors, controllers, computer, etc., positioned at a different location in a distributed system. For example, in some approaches one or more of the operations in method 300 may involve one or more components in a closed system, which may be connected to a central server as part of a larger distributed system. Accordingly, node 301 may include one or more processors and/or AI based models which are located at a central server of a distributed system (e.g., see processor 212 and/or AI module 213 of FIG. 2 above). Moreover, node 302 may include one or more processors which are located at a closed system (e.g., see user device 204 and/or closed storage system 206 of FIG. 2) of a distributed system. Accordingly, commands, code, data, metadata outlining code updates, etc. may be sent between the nodes 301, 302 depending on the approach.

It should also be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches. It should also be noted that in some approaches, the operations of method 300 may be performed in the closed system itself. Accordingly, one or more of the following approaches may be implemented by a processor in a closed system, e.g., as would be appreciated by one skilled in the art after reading the present description.

Looking to FIG. 3A, operation 304 originates at node 302. There, the closed system is initiated. In other words, operation 304 includes supplying power to the components in the closed system, and causing software installed therein to run. Initiating the closed system may thereby include one or more sub-operations that correspond to a predetermined sequence. This predetermined sequence may be reflected in the nominal operating ranges used to determine whether the closed system is performing as anticipated.

In response to the closed system at node 302 being initialized, operation 306 includes sending information associated with various performance metrics of the closed system, to node 301. Accordingly, sub-operations 306a, 306b, . . . , 306n include sending different operating characteristics, e.g., such as CPU overhead memory usage, a current number of processes and threads, etc., to node 301. Despite operation 306 being shown in FIG. 3A as a single step, it should be noted that information corresponding to performance metrics (e.g., such as sensor readings, performance outputs, model generated outcomes, etc.) may continually be sent from the closed system at node 301 to node 302 while the closed system is operational. In other words, performance of the closed system may continually be monitored during operation thereof.

Proceeding to operation 307, the information received from node 302 is initially evaluated to determine whether each of the programs that have begun running in the closed system as a result of it being initiated in operation 304, are registered. In other words, operation 307 evaluates each of the programs currently running on the closed system (e.g., as confirmed with the information received in operation 306), and confirms that each program is permitted to run on the closed system. In some approaches, operation 307 refers to one or more security policies that may outline the programs registered (e.g., allowed) to run on the closed system. In response to determining that a given program running on the closed system at node 302 is not permitted, method 300 proceeds to operation 310. There, operation 310 includes sending one or more instructions to the closed system that cause the unpermitted program to be terminated. However, method 300 advances to operation 312 for each program determined as being permitted to run on the closed system at node 302.

Proceeding now to operation 312, the information corresponding to the performance metrics are evaluated and used to determine if the closed system is operating as intended. In other words, operation 312 includes using the information received from the closed system to gauge how the closed system is performing, and in situations where performance strays from anticipated ranges of values, it may easily detect malicious activity and/or performance issues. Depending on the type and/or amount of information is received in operation 306, the analysis that may be performed in operation 312 may vary. In some approaches, operation 312 may be performed for each program identified as running on the closed system. Operation 312 may thereby be repeated any desired number of times. It should also be noted that the operations of method 300 as a whole may be repeated any desired number of times, e.g., to maintain an accurate understanding of how the closed system is operating in real-time. For example, operations in method 300 may be periodically repeated in an iterative fashion. At least some of the operations in method 300 may thereby be repeated between every 5 seconds, to between every 50 seconds. In other approaches, method 300 may be re-performed every about 1, 2, 3, 4, 5, 6, 7, 8, 9, 10, 15, 19, 20, 39, 50, 100, 120, 150, 200, 1000, etc., seconds. In other approaches, operation 312 may be triggered in response to a predetermined condition being met, e.g., such as an application being run on the closed system.

While operation 312 is not intended to be limited to any particular combination and/or arrangement of sub-operations, FIG. 3A depicts an illustrative approach which shows how the information corresponding to the performance metrics may be used to monitor and control performance in the closed system.

Accordingly, sub-operation 312a is shown as collecting the received information and evaluating it to determine the value for a number of performance metrics experienced at node 301. In some approaches, sub-operation 312a includes determining a number of processes and threads that exist for each program currently running on the closed system. In another approach, sub-operation 312a includes determining current CPU overhead (e.g., usage) for each program running on the closed system. In another approach, sub-operation 312a includes determining current memory consumption for each program running on the closed system.

As previously mentioned, these numbers may be received at node 301 in operation 306 along with the other performance metrics information. Sub-operation 312a may thereby include extracting the desired information associated with the respective performance metrics. Proceeding to sub-operation 312b, a determination is made as to whether each number of processes and threads for the respective program is in a first predetermined range. In other words, sub-operation 312b includes determining whether the number of processes and threads that exist for each respective program, is in the first predetermined range (e.g., a desirable range). As noted above, this predetermined or desirable range corresponds to known operating characteristics of the closed system. Sub-operation 312b thereby effectively includes determining whether the current number of processes and threads are out of the ordinary for any programs running on the closed system.

The flowchart is shown as advancing to sub-operation 312c from sub-operation 312b, despite the outcome of sub-operation 312b. There, sub-operation 312c includes determining whether CPU overhead consumed by each program is in a second predetermined range. Again, this second predetermined or desirable range corresponds to known operating characteristics of the closed system. Sub-operation 312c thereby effectively includes determining whether the current CPU overhead consumed by each program is out of the ordinary for any programs running on the closed system.

Again, the flowchart is shown as advancing to sub-operation 312d from sub-operation 312c, despite the outcome of sub-operation 312c. There, sub-operation 312d includes determining whether memory usage corresponding to each program is in a third predetermined range. Again, this third predetermined range corresponds to known operating characteristics of the closed system. Sub-operation 312d thereby effectively includes determining whether the current amount of memory consumed by each program is out of the ordinary for any programs running on the closed system.

From sub-operation 312d, the flowchart proceeds to sub-operation 312e. There, sub-operation 312e includes evaluating the outcome of sub-operations 312b, 312c, 312d and/or any other analysis performed on the information corresponding to performance metrics of a closed system, and generating an indication of how the closed system is operating. According to one illustrative approach, sub-operation 312e includes issuing a security alert in response to determining that at least one of the programs includes: (i) a respective number of processes and threads that is outside the first predetermined range, and/or (ii) a combined value of the CPU overhead caused by the respective program that is outside a second predetermined range. In other words, the security alert may be generated in response to determining there is an abnormal number of processes and/or threads for a program running on the closed system; or alternatively that CPU overhead caused by a program running on the closed system is undesirably high.

According to another illustrative approach, sub-operation 312e includes determining an amount of memory consumed by each program, and in response to determining that the amount of memory consumed by at least one of the programs is outside a third predetermined range, a security alert is issued. The security alert may outline the program(s) that have consumed more memory than expected, suggest one or more next steps to address the identified malicious programs, force the identified programs to end, etc.

According to still another illustrative approach, sub-operation 312e includes issuing a performance alert in response to determining that the combined value of the CPU usage of at least one of the programs is in a fourth predetermined range. In other words, a performance alert may be issued in situations where a value of the CPU usage corresponding to a given program exceeds a threshold. According to one approach, the fourth predetermined range begins at 100% of nominal CPU usage and extends upwards. Thus, sub-operation 312e may include automatically issuing a performance alert in response to determining that the combined CPU usage of a program unsustainably high.

In another illustrative approach, sub-operation 312e includes adjusting a priority assigned to a given program based on how the performance metrics compare to the predetermined ranges (nominal operating ranges). In some approaches, the priority of a given program may be adjusted (increased or decreased) using “nice” or “renice” commands. However, priorities may be changed using similar processes depending on the approach. For instance, in response to determining that a given program includes: (i) a respective number of processes and threads that are in the first predetermined range, and (ii) a combined CPU usage by the program that is above a predetermined threshold, the priority of the given program is determined. In response to identifying that the given program currently has a low priority, the given program may be forced to end. In other words, the program may be terminated in response to determining the program is performing abnormally and has a low priority. In this situation, it may be more beneficial to simply end a low priority program rather than potentially expose the closed system to malicious activity and/or performance based issues. However, in situations where the given program does not have a low priority (e.g., a normal/medium, high, etc. priority), the priority of the given program is intentionally reduced.

It should be noted that any of the predetermined ranges and/or thresholds herein may be determined using real-time performance, past performance, user preferences, closed system configurations, etc. Moreover, determining whether a value is inside or outside a predetermined range is in no way intended to be limiting. Rather than determining how a value compares to a predetermined range, equivalent determinations may be made, e.g., as to whether a value is above a threshold, whether an absolute value is above a threshold, whether a value is below a threshold, etc., depending on the desired approach.

From operation 312, method 300 advances to 314. There, one or more instructions are sent from node 301 to node 302 for implementation according to the result of operation 312. The one or more instructions sent in operation 314 thereby cause the closed system to operate such that desirable performance is maintained. According to an example, in response to determining that each of the performance metrics fall within the respective desired ranges, the one or more instructions in operation 314 may cause the closed system to maintain current operating settings. In another example, the one or more instructions may cause the closed system to adjust or end a program identified as performing abnormally. In some approaches, operation 314 includes sending warnings (e.g., alerts) that indicate the identified malicious behavior. One or more suggested next-steps may also be provided to address the identified malicious programs, force the identified programs to end, etc.

Thus, by repeating the operations in method 300, the approaches herein are desirably able to maintain secure and efficient performance of the closed system. Again, while the specific approaches herein are in no way intended to be limiting, different combinations of performance metrics may be considered while determining whether the closed system is operating desirably, e.g., as would be appreciated by one skilled in the art after reading the present description.

According to an example, which is in no way intended to be limiting, the nominal operating ranges for a closed system may include: (i) between about 85% to about 95% of maximum CPU overhead; (ii) between about 70 to about 80 threads on a configuration; (ii) between about 0.8 TB to about 1 TB of memory consumed on a 1 TB cache; etc. In some approaches, information corresponding to the performance metrics may be captured by running a dedicated tool, e.g., such as “top” which provides each program (e.g., process or executable) that is running on the system, as well as various performance metrics associated therewith.

According to additional examples, the minimum and maximum number of processes that are registered vs. those running. In situations where there are more processes than the maximum, or less than the minimum, a security alert is raised. In situations where the process is non-critical, and CPU usage is over a certain threshold (e.g., 100%), the processes is terminated. In another example, the minimum and maximum CPU usage registered vs. running may be evaluated. In situations where there are more than the maximum, or less than minimum, a security alert is raised.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
for each of a plurality of programs currently running on a closed system, determining a number of processes and threads for the program;
for each of the programs in the plurality of programs, determining whether the respective number of processes and threads are in a first predetermined range;
for each of the programs determined as having a respective number of processes and threads that are in the first predetermined range, determining CPU usage associated with each of the respective programs; and
issuing a security alert in response to determining that at least one of the programs include: a respective number of processes and threads that are outside the first predetermined range, and a combined CPU usage that is outside a second predetermined range.

2. The CIM of claim 1, wherein the operations are repeated periodically in an iterative fashion.

3. The CIM of claim 2, wherein the period is between about 5 seconds and about 50 seconds.

4. The CIM of claim 1, further comprising:
in response to determining that a given program includes: a respective number of processes and threads that are in the first predetermined range, and a combined CPU usage that is above a first predetermined threshold:
determining a priority of the given program; and
in response to determining the given program has a low priority, ending the given program.

5. The CIM of claim 4, further comprising:
in response to determining the given program has a high priority, intentionally reducing the priority of the given program.

6. The CIM of claim 4, further comprising:
in response to determining that an amount of memory consumed by the given program is outside a third predetermined range, issuing a security alert.

7. The CIM of claim 1, further comprising:
in response to determining that the combined CPU usage of at least one of the programs is in a fourth predetermined range, issuing a performance alert.

8. The CIM of claim 7, wherein the fourth predetermined range begins at 100% of nominal CPU usage and extends upwards.

9. The CIM of claim 1, wherein the closed system is a closed storage system having hybrid flash and hard disk storage.

10. A computer program product (CPP), comprising:
a set of one or more computer-readable storage media; and
program instructions, collectively stored in the set of one or more storage media, for causing a processor set to perform the following computer operations:
for each of a plurality of programs currently running on a closed system, determine a number of processes and threads for the program;
for each of the programs, determine whether the respective number of processes and threads are in a first predetermined range;
for each of the programs determined as having a respective number of processes and threads that are in the first predetermined range, determine CPU usage associated with each of the respective programs; and
issue a security alert in response to determining that at least one of the programs include: a respective number of processes and threads that are outside the first predetermined range, and a combined CPU usage that is outside a second predetermined range.

11. The CPP of claim 10, wherein the operations are repeated periodically in an iterative fashion.

12. The CPP of claim 11, wherein the period is between about 5 seconds and about 50 seconds.

13. The CPP of claim 10, wherein the program instructions are for causing the processor set to further perform the following computer operations:
in response to determining that a given program includes: a respective number of processes and threads that are in the first predetermined range, and a combined CPU usage that is above a first predetermined threshold:
determine a priority of the given program; and
in response to determining the given program has a low priority, end the given program.

14. The CPP of claim 13, wherein the program instructions are for causing the processor set to further perform the following computer operations:
in response to determining the given program has a high priority, intentionally reduce the priority of the given program.

15. The CPP of claim 13, wherein the program instructions are for causing the processor set to further perform the following computer operations:
in response to determining that an amount of memory consumed by the given program is outside a third predetermined range, issue a security alert.

16. The CPP of claim 10, wherein the program instructions are for causing the processor set to further perform the following computer operations:
in response to determining that the combined CPU usage of at least one of the programs is in a fourth predetermined range, issue a performance alert.

17. The CPP of claim 16, wherein the fourth predetermined range begins at 100% of nominal CPU usage and extends upwards.

18. The CPP of claim 10, wherein the closed system is a closed storage system having hybrid flash and hard disk storage.

19. A computer system (CS), comprising:
a processor set;
a set of one or more computer-readable storage media;
program instructions, collectively stored in the set of one or more storage media, for causing the processor set to perform the following computer operations:
for each of a plurality of programs currently running on a closed system, determine a number of processes and threads for the program;
for each of the programs, determine whether the respective number of processes and threads are in a first predetermined range;
for each of the programs determined as having a respective number of processes and threads that are in the first predetermined range, determine CPU usage associated with each of the respective programs; and
issue a security alert in response to determining that at least one of the programs include: a respective number of processes and threads that are outside the first predetermined range, and a combined CPU usage that is outside a second predetermined range.

20. The CS of claim 19, wherein the program instructions are for causing the processor set to further perform the following computer operations:
in response to determining that a given program includes: a respective number of processes and threads that are in the first predetermined range, and a combined CPU usage that is above a first predetermined threshold:
determine a priority of the given program;
in response to determining the given program has a low priority, end the given program;
in response to determining the given program has a high priority, intentionally reduce the priority of the given program; and
in response to determining that an amount of memory consumed by the given program is outside a third predetermined range, issue a security alert.
